(19) United States
(12) Patent Application Publication
(10) Pub. No.: US 2006/0200330 A1
(43) Pub. Date: Sep. 7, 2006

(54) Methods and systems for modeling and simulating biochemical pathways

(75) Inventors: Babu C.V. Suresh, Seoul (KR); Eun Joo Song, Seoul (KR); Young Sook Yoo, Seoul (KR)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KOREA INSTITUTE OF SCIENCE AND TECHNOLOGY

(21) Appl. No.: 11/290,793

(22) Filed: Dec. 1, 2005

(30) Foreign Application Priority Data
Mar. 3, 2005 (KR) 10-2005-0017886

(51) Int. Cl. G06G 7/48; G06G 7/58

(52) U.S. Cl. 703/11

(57) ABSTRACT

The present invention relates to a method for modeling and simulating a biochemical pathway and a system for the same, more particularly to a method for modeling and simulating a biochemical pathway which comprises: developing a mathematical dynamics model that applies biological data of a signal transduction pathway within a biological system such as protein concentration as a parameter; and simulating by using the same. The present invention enables protein functions, activation, interactions between proteins, signal transduction pathways and the like to be determined under overall environment, and a network of signal transduction to be understood in both quantitative and qualitative level. The simulation model of the present invention can be utilized to develop novel substances for a specified use such as medicine design even in a minimal trial. Further, it may promote to easily predict their application to improve the quality of target substance.

### TECHNICAL FIELD

The present invention relates to a method for modeling and simulating a biochemical pathway and a system for the same, more particularly to a method for modeling and simulating a biochemical pathway which comprises: (1) developing a mathematical dynamics model that applies biological data of a signal transduction pathway within a biological system such as protein concentration as a parameter; and (2) simulating by using the same. The present invention enables protein functions, activated state of proteins, interactions between proteins, signal transduction pathways and the like to be determined under overall environmental conditions, and a network of signal transduction to be understood in quantitative and qualitative levels. The simulation model of the present invention can be utilized to develop novel substances for a specified use such as medicine design with a minimal number of trials. Further, it may promote to easily predict their applications to improve the quality of a target substance.

### BACKGROUND ART

Recently, systems biology has been attempted to introduce instruments and methods adopted in several engineering fields. The systems biology aims at elucidating biological complexity on the basis of systematic information in a biological system. In order to explain the biological complexity, studies on signal transduction should be accomplished. Each signal transduction pathway has its own specificity. This property is produced by integrating peculiar combinations in a standard signal transduction cassette within a specified cell.

A general procedure for modeling and simulating a biochemical pathway in a biological system to prove a hypothesis is illustrated in FIG. 1. This method for modeling and simulating the biological pathway is further described hereinbelow.

First, qualitative database information available in a biological system is collected to design a model disturbing a specified subordinate system. Next, experiment sets are designed to measure the change of protein levels based on sensitivity analysis and the experiments are conducted to generate test data. The model is simulated by using kinetic parameters to find out the dynamics of signal transduction pathway. The simulation data is compared with the test data to examine the conformity of in silico data. If confirmed identical, this model becomes useful to be adopted. If partially identical, the model is corrected or amended with regard to its values in parameters and then the simulation data is compared with the test data. By using such a feedback control strategy, the predictive values of the model may converge the actual parameters into a natural biological system.

Traditionally, studies on a signal transduction pathway have been focused on illustrating direct upstream and downstream interactions. Then, these interactions are organized to a primary chain amplification that depends upon cellular effecters onto the cell surface receptor such as metabolic enzyme, channel or transcription activator to regulate this procedure [Weng et al., Science, 284: 92-96, 1999].

Receptor tyrosine kinase (RTK) pathway is a representing signal transduction pathway ever investigated [Schlessinger, Cell, 103: 211-225, 2000]. The action mechanism of RTK and the signal transduction pathway controlled by the same have given an insight into how to generate a specific biological reaction. As stated previously, when RTK is activated, the tyrosine residue may be phosphorylated to gather particular docking proteins and transmit a signal. The signal can be transduced specifically through a particular downstream effecter regulating a particular function.

Epithelial growth factor (EGF) is a peptide growth factor composed of 55 amino acids in a long chain. EGF plays a role in regulating cell growth in the outer part of tissue in a human body. Further, it can be used as a therapeutic agent to treat a lesion and gastric wall injury [Korean Patent Application No. 2000-0008116]. Also, EGF is being highlighted as a medicine to treat podalic ulcer for a diabetes patient.

On the other hand, epithelial growth factor receptor (EGFR), a tyrosine kinase receptor, plays an important role in phosphorylating and dephosphorylating various proteins and inducing differential gene expressions. Further, EGFR regulates cell proliferation, migration, survival and differentiation. EGFR is classified to Erb B receptor group that mediates a signal transduction by using growth factors. Recently, human EGFR inhibitors have been developed by investigating influences on tumor due to the over-expression of EGFR.

EGF regulates the proliferation of PC12 cells. It induces a rapid phosphorylation of EGFR and thereby mediates the phosphorylation and activation of signal transducing substances. The activation of signal transduction reaches the peak when it transmits the signal downstream, including the induction of the expression of immediate early and late genes. The receptors may interact with cellular ligands to guide a biochemical signal transduction, and then lead a biological reaction.

Currently, there have been revealed an increasing number of evidences suggesting that signal transduction systems include mitogen-activating protein kinase (MAKP) pathway as a subordinate system of EGFR [Egan S. E. and Weinberg R. A., Nature, 365: 781-783, 1993]. The signal transduction process can be explained as illustrated in FIG. 2. EGFR activated by EGF interacts with Src homology 2 (SH2) domain within growth factor-receptor-binding protein 2 (Grb 2) to initiate the signal transduction via Ras and MAPK proteins. Grb 2 may bind EGFR directly or via Shc protein containing another SH2 domain. The coupling protein Grb2 plays an important role in transducing a signal from EGFR kinase to Ras protein.

SH3 domain within Grb 2 may bind son-of sevenless (Sos), a guanine nucleotide-release factor to stimulate the activation of Ras protein by converting Ras-GDP to Ras-GTP in the Ras protein. In a downstream process, Raf protein becomes phosphorylated thereby activating mitogen-activating protein kinases 1 and 2 (MEK 1 and MEK 2) which in turn activates extracellular signal-regulating kinases 1 and 2 (ERK 1 and ERK 2), wherein the above protein kinases are phosphorylating on tyrosine and threonine residues. When MAP kinase is activated, transcription factors present in cytoplasm and nucleus (substrates for ERK 1 and 2) are phosphorylated and activated to stimulate the expression of specific target genes, thereby stimulating biological reactions accordingly.

Although numerous researches have been conducted to elucidate EGFR signal transduction mechanisms, the basic mechanism that regulates cellular reactions has not been yet fully understood because EGFR signal transduction network has not been explained from the qualitative aspect. In order to describe the system dynamics, several modeling instruments substituting the motion rule into a model have been utilized [Weng et al., Science, 284: 92-96, 1999; Hatakeyama et al., Biochem. J., 373: 451-463, 2003; Schoeberl et al., Nature Biotechnol., 20: 370-375, 2002]. The biochemical structure was mathematically expressed by using the motion rule and the network route specifying a cytochemical signal transmission (constructing a network of signal transduction), effects and provisions of reaction formula, and constant(s) of each particular event. Such a kinetic simulation computer model enables to analyze the transmission of information into a cell and diagnose the status of signal transduction systematically to inform the operation of signal transduction network.

For the past few years, the modeling of dynamics in a signal transduction pathway has been established as a remarkable field of researches. In these researches, the data analyses for a signal transduction system were performed to identify its characteristics which have not been able to be observed by the primary examination. [Bhalla U. and Iyengar R., Science, 28: 381-387, 1999]. A number of different approaches aiming at developing EGFR signal transduction model for a computer analysis have been suggested [Weng et al., Science, 284: 92-96, 1999; Hatakeyama et al., Biochem. J., 373: 451-463, 2003; Schoeberl et al., Nature Biotechnol., 20: 370-375, 2002; Yunchen G. and Xin Z., FEBS Lett., 554: 467-472, 2003; Sasaoka et al., J. Biol. Chem., 269: 32621-32625, 1994; Dario et al., J. Biol. Chem., 270: 27489-27494, 1995; Favata et al., J. Biol. Chem., 273: 18623-18632, 1998]. Many studies have been focused on differential equations and pathway simulations with numbers. The dynamic simulation has achieved an advance in studies on signal flow and complex signal transduction pathway. However, considering a final model, these reports are at the level of merely providing quantitative data regarding the dynamics of initial events in EGFR signal transmission.

US 2002/0068269 A1 discloses the soft flat form to investigate a signal transmission mechanism by using TNF-α receptor signal transduction pathway system. In the meantime, the present invention is focused on EGF receptor signal transduction pathway system to develop a computer model comprising quantitative information. Further, the present invention measures the change in various conditions according to protein concentrations to analyze the activity of a target protein. Therefore, the present invention clearly differs from the above US patent.

In order to solve above-mentioned problems, the present inventors have made extensive efforts to develop a mathematical dynamics model that can apply dynamic parameters of signal transduction pathway within a biological system such as protein concentration by using a differential equation on the basis of reaction rate formula and enzymatic reaction-related equation (Michaelis-Menten equation rate), and then to simulate the same. As a consequence, they have confirmed that this simulation enables overall signal transduction networks to be understood and predicted both quantitatively and qualitatively and completed the present invention successfully.

Therefore, the object of the present invention is to provide methods for modeling and simulating a biological system by using kinetic information of proteins acting on a signal transduction pathway in a quantitative and qualitative level.

### DISCLOSURE OF THE INVENTION

The present invention has a feature to provide a method for modeling a biochemical pathway, comprising: (1) collecting cellular environment information in a biochemical pathway; and (2) modeling by using the cellular environment information and a differential equation on the basis of reaction rate formula and Michaelis-Menten equation.

In addition, the present invention has a feature to provide a method for simulating a biochemical pathway, comprising steps: (1) providing cellular environment information and input information in a biochemical pathway; (2) modeling by using the cellular environment information and a differential equation on the basis of reaction rate formula and Michaelis-Menten equation; and (3) displaying the result simulated.

### BRIEF DESCRIPTION OF THE DRAWINGS

The above and other objects, features and other advantages of the present invention will be more clearly understood from the following detailed description taken in conjunction with the accompanying drawings, in which;

FIG. 1 depicts a block diagram of the process for modeling and simulating a biochemical pathway;

FIG. 2 depicts a conceptual diagram of proteins constituting EGFR signal transduction pathway and a process for phosphorylating and dephosphorylating the proteins;

FIG. 3 depicts a circuit of EGFR signal transduction pathway mediated by EGF;

FIGS. 4a to 4c depict the activation levels of Raf, MEK and ERK by using a computer simulation;

FIGS. 4d to 4e depict the phosphorylation of MEK and ERK in PC12 cells by performing Western blot analysis;

FIGS. 5a to 5c depict a reaction rate in the phosphorylation and dephosphorylation of Raf, MEK and ERK, by processing with a computer;

FIGS. 6a to 6c depict a computer simulation of the cascade amplification in EGFR signal transduction mediated by EGF at particular EGF concentration: wherein
FIG. 6a illustrates the activation of EGFR;
FIG. 6b, the activation of Shc;
FIG. 6c, the formation of Ras-GTP;
FIG. 6d, the activation of Ras;
FIG. 6e, the activation of Raf;
FIG. 6f, the activation of MEK; and
FIG. 6g, the activation of ERK;

FIGS. 7a to 7g depict the computer simulation of EGFR signal transduction according to the number of EGFR: wherein
FIG. 7a illustrates the activation of EGFR;
FIG. 7b, the activation of Shc;
FIG. 7c, the formation of Ras-GTP;
FIG. 7d, the activation of Ras;
FIG. 7e, the activation of Raf;
FIG. 7f, the activation of MEK; and
FIG. 7g, the activation of ERK;

FIG. 8a depicts the conversion of MEK phosphorylation according to ERK activation levels by performing a computer analysis;

FIGS. 8b and 8c depict the effects of PD98059 and U0126 during MEK and ERK activation by performing Western blot analysis; and

FIG. 9a depicts a system of a biochemical pathway and 9b depicts a simulation module [10: input module, 20: simulation module, 21: graphic user interface, 22: inference engine, 23: compiler, 30: database, 40: display module, 100: system, 200: user].

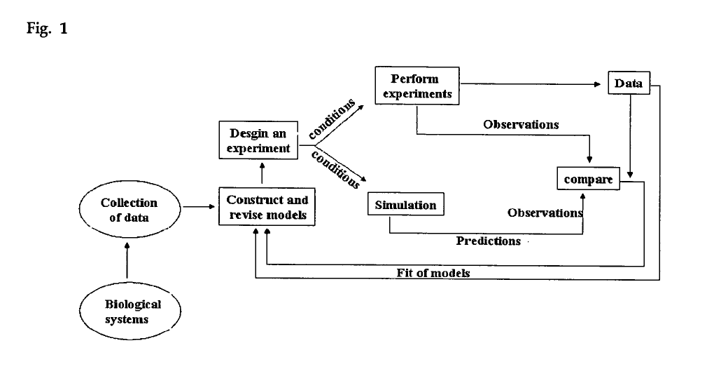

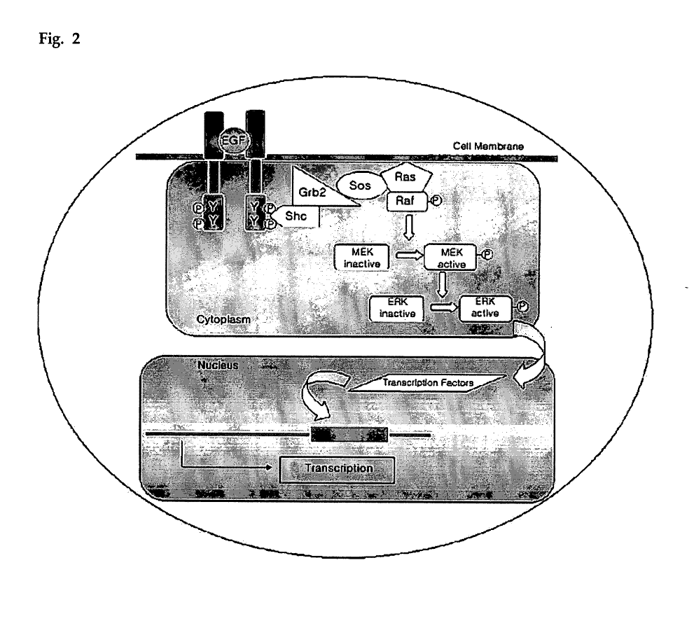

### BEST MODE FOR CARRYING OUT THE INVENTION

Hereinafter, the present invention will be described in greater detail as follows.

The present invention relates to a method and a system for modeling and simulating a biochemical pathway that comprises: (1) developing a mathematical dynamics model that applies biological data of a signal transduction pathway within a biological system such as protein concentration as a parameter; and (2) simulating by using the same. The present invention enables to predict protein functions, activated state of proteins, interactions between proteins, signal transduction pathways and the like under overall environmental conditions, and thereby understand a network of signal transduction at both quantitative and qualitative levels. The simulation model of the present invention can be utilized to develop a novel substance for a specified use such as medicine design with a minimal number of trials. Further, it may mediate easy prediction of its application to improve the quality of target substance.

The method for modeling and simulation of the present invention integrates broad information on a biochemical pathway in order to evaluate and predict the effect of stimuli on the biochemical pathway. Preferably, the information can include cellular environment information and input information.

The “cellular environment information” means all environmental factors that may influence on simulations. Preferably, the cellular environment information is comprised of cellular materials, processes, types and components; protein types, structures, compositions and functions; modifications such as activating or inhibitory effects; and the like.

The “input information” is a concept comprised of protein context, stimuli, knockout, endpoint and the like. On the basis of the input information, the simulation is conducted to derive an intended result.

The information on the protein type, structure, composition and function can be obtained by using any Web-based flat forms, if accessible by those skilled in the art such as www.ncbi.nlm.nih.gov and the like.

In order to perform the modeling of the present invention, the mathematical formula comprised of kinetic parameters such as protein concentration and rate constant can be utilized. Preferably, the mathematical formula can include those for reaction rate, Michaelis-Menten equation and the like.

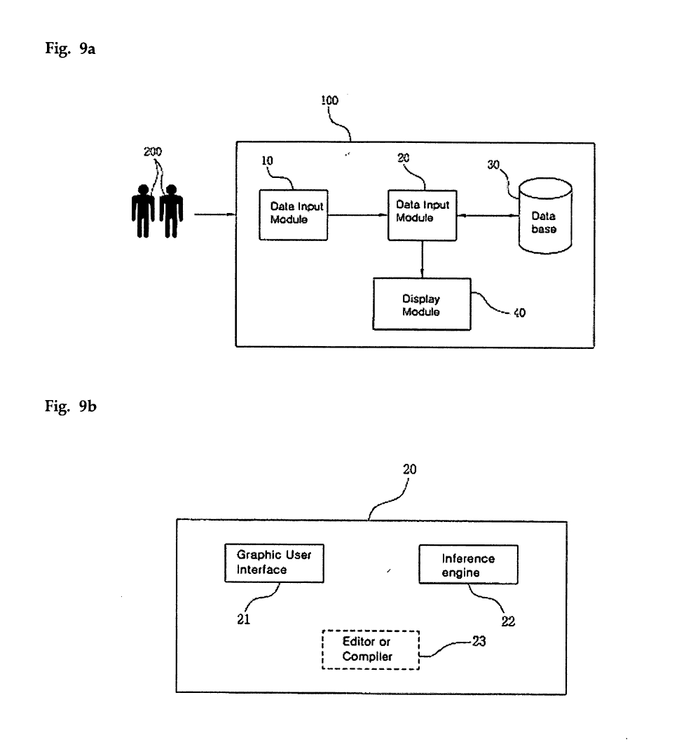

The present invention provides a system for simulating a biochemical pathway comprising: (1) a data input module 10; (2) a simulation module 20; (3) a database 30; and (4) a display module 40 (FIG. 9a).

The cellular environment information and the input information necessary for the modeling and the simulation can be provided into the data input module 10 by conventional processes in this art. Preferably, the information can be manually inputted by direct keyboard operation or by using an automated data input device. On the basis of the cellular environment information and the input information provided into the data input module 10, the simulation module 20 can determine the order of events occurring under a designated cellular environment to simulate a biochemical pathway. The simulation module 20 displays a simulated pathway through the display module 40 documentarily or graphically.

The simulation module 20 is connected to one or more users 200, a database 30 and the display module 40 and comprised of all processing logics for the system. Preferably, the simulation module 20 is comprised of a graphic user interface 21 and an inference engine 22, and further can be comprised of an editor or a compiler 23 selectively (FIG. 9b).

The graphic user interface 21 collects the input information from users. The user provides the simulation module with various input types by conducting various data input processes. New data can be sent to database through the graphic user interface. The simulation module can receive the input information through the database.

The logic engine 22 is operated with the database. Depending upon cellular environments, it evaluates the order of logic statements to determine cellular events. The logic engine can describe a signal transduction pathway based on the database on cellular compositions and reactions already disclosed.

The editor or the compiler 23 can be utilized to input new definitions on user's characters, concepts and events; edit the definition; and/or edit all changes on the database.

The database 30 can store all information necessary to analyze biochemical pathways. Preferably, the database can store the cellular environment information and the inputted information.

Preferably, the system of the present invention can be embodied in a server containing a work station operating Microsoft Windows, NT, Windows 2000, UNIX, LINUX, XENIX and so on. It is natural that any apparatus can be utilized, if capable of operating the program of the present invention. Preferably, the apparatus can be general computers, a computer for a specified use, a programmed microprocessor, or a micro-controller.

As for the data input module 10 and the display module 40 in the system, the conventional ones can be used without any limitations.

In order to confirm the system and the method of the present invention, the present inventors have conducted a modeling and a simulation focused on an intracellular signal transduction stimulated by growth factors.

Growth factors are local signal transduction materials that transmit information between cells and thereby influence cellular interactions. In initiating the intracellular signal transduction pathway, the reaction between a growth factor and its receptor and the oligomerization of the receptor are very important. The receptor brings about the interaction of molecules, if activated. Then, it amplifies a signal through the signal transduction mechanism to express a target gene. Although each growth factor may go through the signal transduction pathway by using the same molecule, each growth factor enables to activate numerous signal transduction pathways which result in various kinds of cellular reactions. The analysis of those various signal transduction pathways can elucidate the interactions among various chemical compounds within the signal transduction at various levels. Therefore, a reaction to a particular growth factor varies according to the degree of interaction between signal transduction materials.

Proteins acting on a signal transduction play a main role in transmitting and processing information rather than chemical conversion of metabolic intermediates. The proteins transmit the information from cell membrane to genes. The proteins amplify signals within a signal transduction network to integrate, or binds them on a circuit acting as information storage. In fact, the signal transmission is similar to a chemical reaction of small molecules, and thus enables to delineate molecular interactions by using a kinetic and thermodynamic terminology.

Until now, the highly inter-connected system of signal transduction has not been understood entirely. During the past decade, cell biology, biochemistry and molecular biology and the like have shown a great advance. Further, physiological and pathological mechanisms have been extensively explored to provide technologies for new information. Nevertheless, in order to optimize cellular reactions at a target biochemical event, it is required to understand various influential factors and integrate the information.

In the present invention, the mathematical kinetic model is designed on the basis of biological data collected from a biological system such as protein concentration. Simulation is performed based on a given model and then confirmed. The biological data is preferably a protein concentration related with its activity as a kinetic parameter. The mathematical modeling enables the concentration of signal transduction chemicals to be quantified. Further, the mathematical modeling enables the knock-out of a particular chemical and the intracellular motion of signal transmitting molecules to be investigated.

The functional module is defined at a critical level of a biological tissue containing several molecules in various types. Therefore, intracellular reactions such as signal transmission or protein synthesis can be separated to several module structures. Such a module can be isolated or connected. If connected together, the function of particular module may influence other modules. As a result, the cell capacity that integrates information derived from several sources to send a particular reaction can be achieved by the relationship between functional modules. In the present invention, this module concept is applied to conceive the mathematical model. Therefore, this model may evaluate various biological phenomena, and further integrate biochemical events such as cross-talk between signals, and positive or negative feedbacks.

This procedure suggested in the present invention can deal a variety of dynamic intracellular processes from a network of gene regulation to an intercellular and intracellular signal transduction. Further, the entire proteins within a signal transduction pathway including enzymatic actions can be considered in order to conduct the modeling.

### EXAMPLES

Practical and presently preferred embodiments of the present invention are illustrated as shown in the following Examples.

However, it will be appreciated that those skilled in the art, on consideration of this disclosure, may make modifications and improvements within the spirit and scope of the present invention.

<Example> Application for EGFR Signal Transduction Pathway

1. Modeling and Simulation

In order to verify the mathematical kinetic model of the present invention, EGFR signal transduction kinetic model comprising (a) elements acting on MAPK signal transduction induced by EGF and (b) kinetic information used for their activation was developed.

The present inventors have adopted PC12 cell as a biological system to explore a computer model. The PC 12 cell has been already reported to express approximately 20,000 receptors on its surface.

We have integrated the concentration as well as EGFR pathway structure, rate formula and kinetic parameters of a particular event into a biochemical simulator. The computer simulation was conducted by using an Intel Pentium PC. The simulator measured the change of concentrations in each signal transmitting substance on the basis of the biochemical data. The resulting data was considered as a signal.

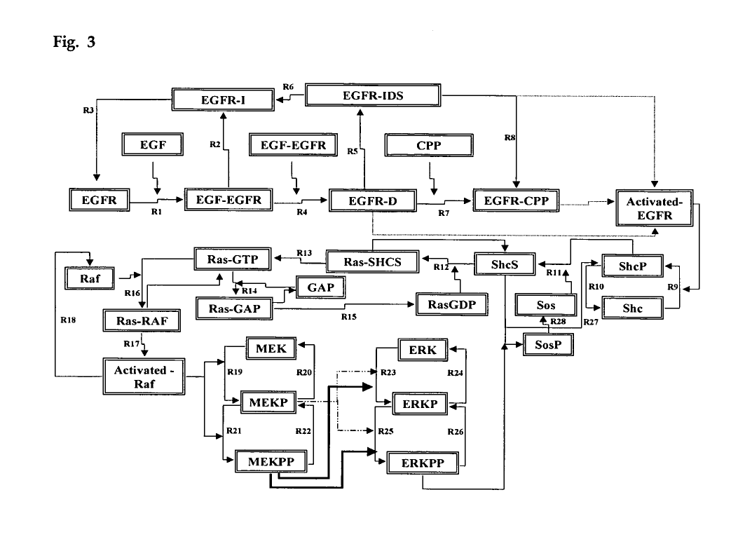

FIG. 3 depicts the circuit of EGFR activated downstream protein signaling induced by EGF. The notation of R1 to R28 is summarized in Table 1.

In FIG. 3, R1 to R8 makes a simulation completed to activate EGFR dimers and inherent EGFR tyrosine kinase domain within a neural transduction pathway, and further form EGF-EGFR complex and a completed simulation intracellular internalization. EGFR activated by Shc phosphorylation starts to activate the intracellular signal transduction mechanism, stimulating Ras and Raf (the intracellular mitogen-activating protein kinases containing guanine nucleotide binding proteins), MEK (MAPK or ERK kinase) and ERK (extracellular signal regulating kinase) protein kinase. In this model, the activity of B-Raf is regulated by both its binding with Ras-GTP and its phosphorylation as in Raf-1 activity.

In the model, all simulations were conducted by using Gepasi Software Version 3.21. These simulations are made of signal transmitting substances and independent reaction steps. For this purpose, a proper reaction rate formula and a dynamic constant were defined. The software derives from this data, a set of differential equation describing the variation in concentration of a signal transduction mediator according to time passage.

This modeling generated a simulation by the process, (1) inputting a biochemical equation into the software and (2) substituting the rule of dynamics and dynamic constants corresponding to the same. The dynamic equation and parameters are summarized in Table 1. The initial concentrations of cellular molecules are demonstrated in Table 2. The biochemical signal transduction mechanism of EGFR was simulated on the basis of following reactions.

TABLE 1

| Reactions | Kinetic equations | Paramters* |
|---|---|---|
| R1 | k₁[EGF][EGFR] − k₋₁[−EGFEGFR] | k₁ = 384.2 × 10⁶, k₋₁ = 0.73 |
| R2 | k₂[f][Eₑ + [1 − Eₑ][1 − [exp[−[[t/dTe]³]]]]][EGF − EGFR] | k₂ = 0.7, f = 0.2, Eₑ = 0.12, ΔT = 6.5 |
| R3 | [k₃][Rᵢ] − [ k₋₃[f][Eₑ + | k₃ = 0.048, k₋₃ = 0.7, f = 0.2, Eₑ = 0.12, ΔT = 6.5 |
| | [1 − Eₑ][1 − [exp[−[[t/dTe]³]]]]][EGF] | |
| R4 | k₄[EGF − EGFR]² − k₋₄[EGFR − D] | k₄ = 0.00138 |
| R5 | k₅[f][Eₑ + [1 − Eₑ][1 − [exp[−[[t/dTe]³]]]]][EGFR − D] | k₅ = 0.35, f = 0.2, Eₑ = 0.12, ΔT = 6.5 |
| R6 | k₆[Eₑ + [1 − Eₑ][1 − [exp[−[[t/dTe]³]]]]][EGF − EGFR] | k₆ = 0.35, Eₑ = 0.12, ΔT = 6.5 |
| R7 | [[k₇P][f][EGF − EGFR]] − [[k₋₇][EGFR − CPP] | k₇ = 1, k₋₇ = 0.00347, f = 0.2 |
| R8 | k₈[Eₑ + [1 − Eₑ][1 − [exp[−[[t/dTe]³]]]]] [EGFR − CPP] | k₈ = 0.35, Eₑ = 0.12, ΔT = 6.5 |
| R9 | [k₉][2][EGFR − D + EGFR − IDS + EGFR − | k₉ = 12, K₉ = 6000 |
| | CPP][SHC]/[K₉ + [Shc]] | |
| R10 | V₁₀[ShcP]/[K₁₀ + [ShcP]] | V₁₀ = 300000, K₁₀ = 6000 |
| R11 | k₁₁[ShcP][Sos] − k₋₁₁[ShcSos] | k₁₁ = 0.002, k₋₁₁ = 3.81 |
| R12 | k₁₂[RasGDP][ShcSos] − k₁₂[Ras − ShcSos] | k₁₂ = 0.0163, k₋₁₂ = 10 |
| R13 | k₁₃[Ras − ShcSos] | k₁₃ = 15 |
| R14 | k₁₄[Ras − GTP][GAP] − k₋₁₄[Ras − GAP] | k₁₄ = 0.005, k₋₁₄ = 60 |
| R15 | k₁₅[Ras − GAP] | k₁₅ = 720 |
| R16 | k₁₆[Ras − GTP][Raf] − k₋₁₆[Ras − Raf] | k₁₆ = 0.0012, k₋₁₆ = 3 |
| R17 | k₁₇[Ras − Raf] | k₁₇ = 27 |
| R18 | V₁₈[Activated Raf]/[K₁₈ + [Activated Raf]] | V₁₈ = 97000, K₁₈ = 6000 |
| R19 | [Activated Raf][MEK]k₁₉/[K₁₉ + [MEK]} | k₁₉ = 50, K₁₉ = 9000 |
| R20 | V₂₀[MEKP]/[K₂₀ + [MEKP]] | V₂₀ = 92000, K₂₀ = 600000 |
| R21 | [Activated Raf][MEKP]k₂₁/[K₂₁ + [MEKP]] | k₂₁ = 50, K₂₁ = 9000 |
| R22 | V₂₂[MEKPP]/[K₂₂ + [MEKPP]] | V₂₂ = 920000, K₂₂ = 600000 |
| R23 | [MEKP + MEKPP][ERK]k₂₃/[K₂₃ + [ERK]] | k₂₃ = 8.3 K₂₃ = 90000 |
| R24 | V₂₄[ERKP]/[K₂₄ + [ERKP]] | V₂₄ = 200000, K₂₄ = 600000 |
| R25 | [MEKP + MEKPP][ERKP]k₂₅/[K₂₅ + [ERKP]] | k₂₅ = 8.3 K₂₅ = 90000 |
| R26 | V₂₆[ERKPP]/[K₂₆ + [ERKPP]] | V₂₆ = 400000, K₂₆ = 600000 |
| R27 | [ERKPP][SHCS][k₂₇]/[K₂₇ + [SHCS]] | k₂₇ = 1.6, K₂₇ = 60000 |
| R28 | V₂₈[SosP]/[K₂₈ + [SosP]] | V₂₈ = 75, K₂₈ = 20000 |

*Parameters used in this model were derived from published experimental studies [13, 21 and therein]. I^{st} and II^{nd} order rate constants are expressed as min⁻¹ and molecules⁻¹ min⁻¹ respectively. Individuals reactions rates, Vₘₐₓ and Kₘ values were in molecule cell⁻¹ minute⁻¹ and molecule cell⁻¹.

TABLE 2

| Protein | Concentration (molecules/cell) |
|---|---|
| EGF | 100* |
| EGFR | 11,100 |
| EGFR-1 | 4,000 |
| Shc | 30,000 |
| Sos | 20,000 |
| GAP | 15,000 |
| Ras | 20,000 |
| Raf | 10,000 |
| MEK | 360,000 |
| ERK | 750,000 |

(*in nM)

Above all, the reaction rate formula between EGF and EGFR was utilized.
<Reaction Formula 1>

$$\begin{matrix}\underline{X + Y {⇆}^{{k}_{1}} Z} \\ {}_{{k}_{\text{-} 1}}\end{matrix} \qquad 〈 Reaction Formula 1 〉$$

In the above Reaction Formula 1, X is EGF; Y is EGFR; Z is EGF-EGFR complex; k₁ is a forward rate constant; and k₋₁ is a reverse rate constant.

The above Reaction Formula 1 is applied to the following Mathematical Formula 1 to conduct the modeling.

<Mathematical Formula 1>
d[EGP]/dt=−k₁[EGF][EGFR]+k₋₁[EGF−EGFR]

Since the phosphorylation and the dephosphorylation of each protein are a sort of enzymatic reaction, Michaels-Menten equation as described in Reaction Formula 2 is utilized.
<Reaction Formula 2>

$$S + E {{⇆}_{{k}_{2}}}^{{k}_{1}} E S {⇆}^{{k}_{3}} P + E \qquad 〈 Reaction Formula 2 〉$$

In the above Reaction Formula 2, E is an enzyme; S is a substrate; ES is an enzyme-substrate complex; P is a product; and k₁, k₂ and k₃ are rate constants.

The Reaction Formula 2 is applied to following Mathematical Formula 2 to conduct a modeling.

<Mathematical Formula 2>
d[E]/dt=−k₁[E][S]+[k₂+k₃][ES]
d[P]/dt=k₃[ES]

In the above Mathematical Formula 2, E is an enzyme; S is a substrate; ES is an enzyme-substrate complex; P is a product; and k₁, k₂ and k₃ are rate constants.

In addition, sensitivity analyses were conducted regarding the initial concentration change and the number of receptors.

The receptor internalization rate is obtained by using Mathematical Formula 3 in order to add steps corresponding to the intracellular internalization of receptor-ligand complex (EGF-EGFR) excluded in the model.

<Mathematical Formula 3>
d(t)=ε+(1−ε)[1−e^{-(t/ΔT)3}]

In the above Mathematical Formula 3, Δt is a time delay; εk is a rate constant before adding a ligand; and k is a constant at normal state after adding a ligand.

Accordingly, the internalization rate constant becomes a function of time, as illustrated in k(t)=kd(t). The internalization rate varies further due to factor f (the fraction integrating receptors located on the cell surface). The number of proteins connecting a membrane groove is deduced to remain validly during the simulation period. As a result, this affects the rate constant reflecting the reaction between a membrane groove and an activated receptor.

2. Comparison of Experiment and Simulation

In the first simulation series, the present inventors has simulated a model at EGF=100 nM, as conducted in a practical experiment and other modeling studies. As a result, we have identified the activation level of MARK signal transduction molecules.

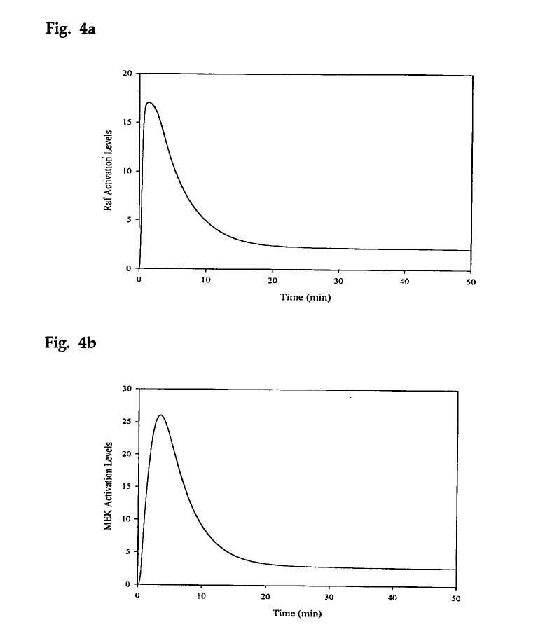

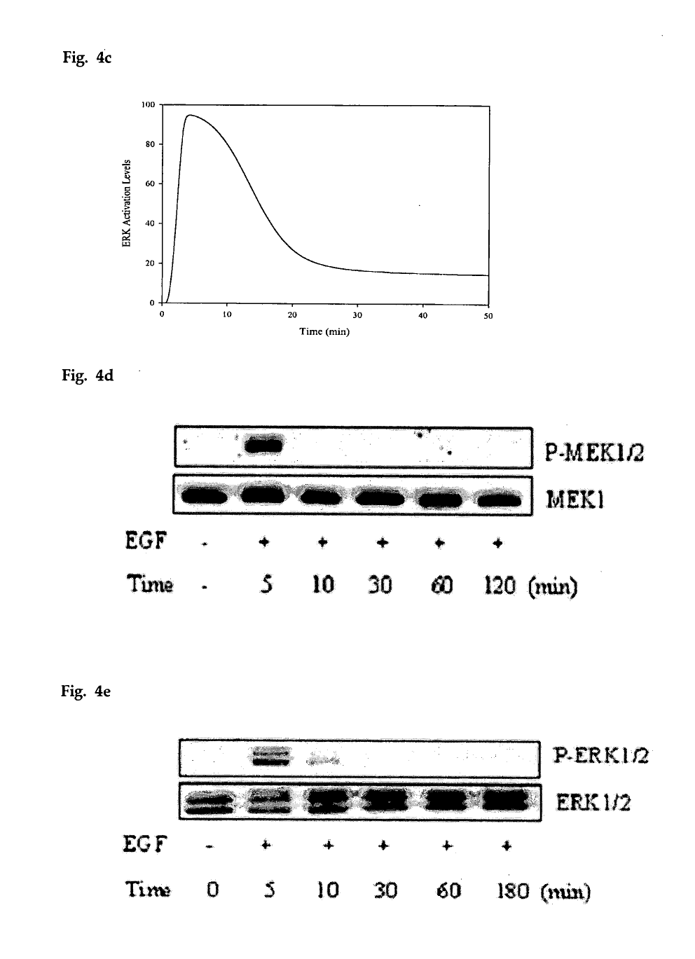

FIG. 4a to 4c exemplify the activated status of Raf, MEK and ERK. The Raf activation reached the maximum value (17%) within approximately 1.4 min, and then reduced as time lapsed. Such an instant activation of Raf may transmit the signal next to phosphorylate MEK. The MEK activation reached the maximum value (26%) at 3.4 min, which is similar to that of Raf in pattern. Similarly, the signal can be transmitted from MEK to ERK to activate ERK. As predicted in the above, the ERK variation indicated the instant ERK activity decreasing slowly in the overall range according to a time period (reaching a maximum value (94.7%) at 4.3 min).

In order to confirm the simulation, PC12 cells treated with EGF (100 ng/ml) were used to measure the time data tracking the activation levels of MEK and ERK, respectively. As predicted, the Western blot analysis showed the temporary activation of MEK and ERK, respectively (FIGS. 4d and 4e). Western blot analysis was performed as follows. PC12 cells were treated with 100 ng/ml EGF for 0 to 120 min. Dissolved protein samples were reacted by using anti-phosphorylated MEK antibodies and anti-diphosphorylated ERK antibodies. Then, the resultant was reacted with anti-HRP (horse radish peroxidase)-conjugated secondary antibodies and confirmed the presence of a band via ECL chemoluminscence.

The result of the activation in MAPK signal transduction process was very complex and varied according to its time of duration. The simulation data and test data collected in this study was confirmed to accord with reference data already reported [Hunter T., Methods in Enzymology, Academic Press, Inc., New York, 1991].

3. Data Evaluation in Initial Concentration of Protein

For the evaluation of the fluctuation, it is important to identify the correlation of each signal transduction component for each cell function. Further, the intensity of ERK signal and its duration are crucial to the final biological result. In order to manipulate the result, the initial concentrations of proteins were scanned systematically, and then estimated to analyze the signal transduction system with regard to the intensity of ERK signal. The changes in protein concentration and the maximal activation of ERK were measured and summarized in Table 3.

TABLE 3

| | Initial concentration | ERK activation level |
|---|---|---|
| Protein molecules | (molecules/cell) | (%) |
| EGFR | 5500 | 94.3 |
| | 11100 | 94.7 |
| | 100000 | 95.1 |
| | 200000 | 95.1 |
| Shc | 15000 | 94.0 |
| | 30000 | 94.7 |
| | 60000 | 94.8 |
| | 120000 | 94.9 |
| Sos | 10000 | 87.1 |
| | 20000 | 94.7 |
| | 40000 | 96.2 |
| | 80000 | 96.6 |
| Ras | 10000 | 78.7 |
| | 20000 | 94.7 |
| | 40000 | 96.9 |
| | 80000 | 97.5 |
| Raf | 5000 | 68.4 |
| | 10000 | 94.7 |
| | 20000 | 98.4 |
| | 40000 | 99.0 |
| MEK | 18000 | 30.3 |
| | 360000 | 94.7 |
| | 720000 | 94.6 |
| | 1440000 | 94.6 |
| ERK | 375000 | 94.1 |
| | 750000 | 94.7 |
| | 1500000 | 91.4 |
| | 3000000 | 57.1 |

The over-expression of receptors may exert potential influence on cellular reactions in several signal transduction pathways. The effects of the number of EGFR are described as follows. Briefly, the activation level of ERK was observed to be very sensitive as the initial number of EGFR increased. Further, ERK phosphorylation appeared consistent in its pattern and accorded with reference data already reported [Schlessinger J. and Ullrich A. Neuron., 9: 383-391, 1992].

Shc is an upstream protein of Ras and phosphorylates a tyrosine residue by reacting with EGF to bind the phosphorylated EGFR. The simulation at various initial Shc concentrations was conducted several times and revealed 94% of ERK activation. This result suggests that MAPK activation may be processed through the Shc-dependent pathway, a seemingly more efficient pathway. EGFR activation induces to increase the activity of guanine nucleotide exchange factor (GEF; Sos). EGFR may be linked to ERK by binding Grb2.Sos complex or by using a coupling protein through a multimeric complex. The time data tracking different Sos molecules suggested 87-96% of ERK activation in a consistent pattern at a higher Sos concentration and later restored to a basic level.

Ras acts on MAPK signal transduction as a switch converting on and off and centralizes several signal transduction pathways to activate. As illustrated in Table 3, the over-expression of Ras enabled its activity to reach 97.5% at maximum when Ras concentration was fixed at 80,000 molecules/cell. Interestingly, ERK still maintained its activity under the same condition even after 50 min (>50% of total activity). It is concluded that the increase of Raf or MEK activities is not necessary to reach a high level of ERK activation. In detail, Raf is an only protein determined to reach 99% of ERK activation when fixed at 40,000 molecules/cell. Further, Raf maintained ERK activation until 37% after 50 min. It was thus verified that the amount of Raf enables the pathway to regulate the ERK activation. In contrast, the result of simulation at a particular ERK concentration was opposite to those of Raf and MEK in pattern. That is, ERK activation decreased as the number of ERK molecules increased. Besides, ERK still maintained 30% of its activity for a period longer than the time for fixing at 375,000 molecules/cell.

In order to understand details of a signal transduction system at molecular level, it is important to study its influences of over-expression of proteins involved in signal transduction according to various cellular reactions. In this aspect, researchers become focused on observing a variety of cellular reactions occurring in connection with a target protein in the course of over-expressing numerous proteins. In detail, the initial concentrations of various proteins are intentionally changed to observe the over-expression patterns of those proteins and then the result of intracellular system is evaluated by the degree of ERK activation. As a consequence, functions of proteins are being identified in the course of obtaining information on the correlation between over-expressed proteins and a target protein.

4. Effects of Phosphorylation and Dephosphorylation

The phosphorylation and dephosphorylation are essential elements in cell signal transduction. This reaction may activate or terminate a number of important cellular events. The phosphorylation and dephosphorylation processes mediated by a kinase and a phosphatase provide an on/off mechanism in various cellular reactions. The regulation of phosphorylation/dephosphorylation during a signal transduction may be slightly restricted in the rate as compared to those at normal state. In order to elucidate the mechanism and the process regulated by phosphorylated proteins, the rates of phosphorylation/dephosphorylation should be examined.

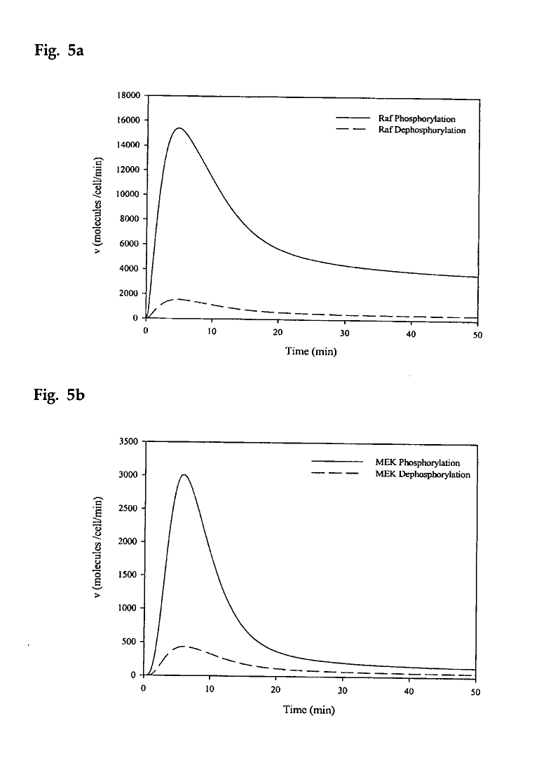

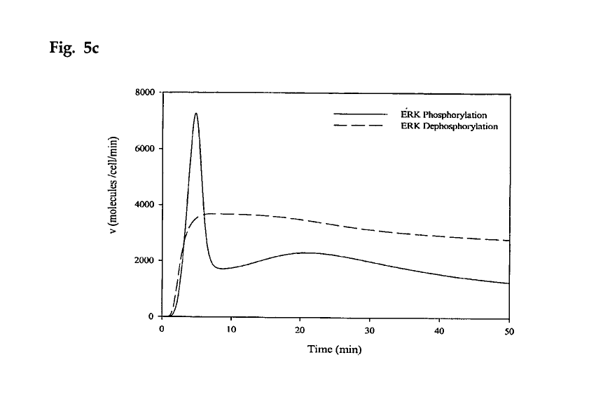

Accordingly, in order to understand the biochemical reactions of kinase and phosphatase in amplifying signals, as the subsequent step of simulation process, the reaction rates of phosphorylation and dephosphorylation are monitored. FIGS. 5a, 5b and 5c depict the reaction rates in the phosphorylation and dephosphorylation of Raf, MEK and ERK. At first, the initial reaction of phosphorylation was observed to be higher than that of dephosphorylation. This result revealed the signal amplification. The experimental curves showed that the signal recognized by kinase/phosphatase should change the catalytic activity of enzymes or inactivate available enzymatic fractions so as to influence the concentrations continuously or instantly. This concentration change indicates a signal amplification which brings about biochemical reactions within a cell. The emergent properties in a signal transduction network can be determined by measuring the reaction rate of the cascade amplification of phosphorylation and dephosphorylation. Furthermore, the reaction rate of the phosphorylation/dephosphorylation analyzed according to time passage may provide a hint to clarify experimental conditions suitable for investigating kinetics of kinase/phosphatase in signal transduction.

Protein phosphorylation plays an important role in a signal transduction system. In signal amplification, a protein at an early stage of the signal transduction phosphorylates a target protein in a later stage of the signal transduction, and thus the phosphorylation/dephosphorylation is an essential process in delivery of information. The ratio of phosphorylation and dephosphorylation of proteins is differentially regulated between when it is under signal transduction and when it is at normal state. Therefore, the reaction rate of phosphorylation and dephosphorylation should be measured precisely in order to tell whether the computer model of the present invention reflects any signal amplification with sensitivity and to investigate the mechanism and the procedure regulated by the phosphorylated proteins.

5. Evaluation of Affinities for EGF and EGFR

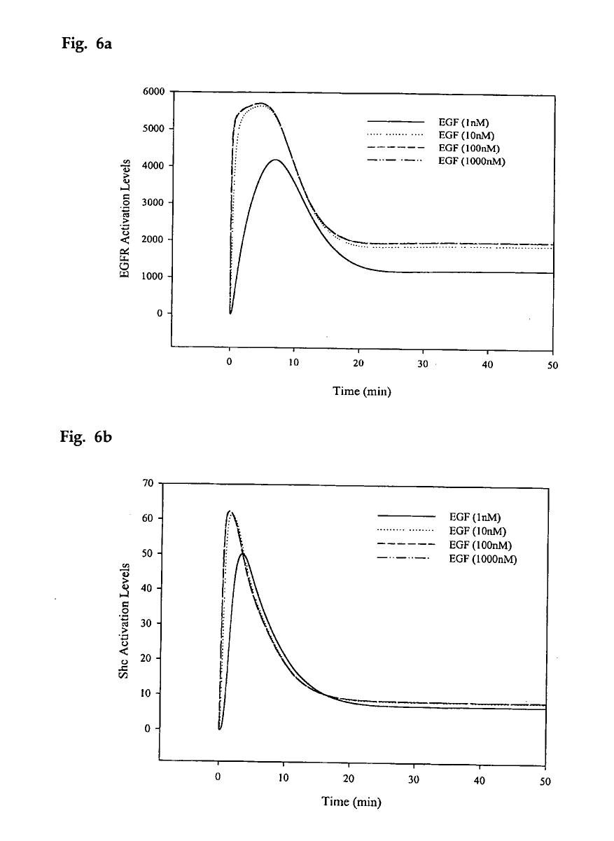

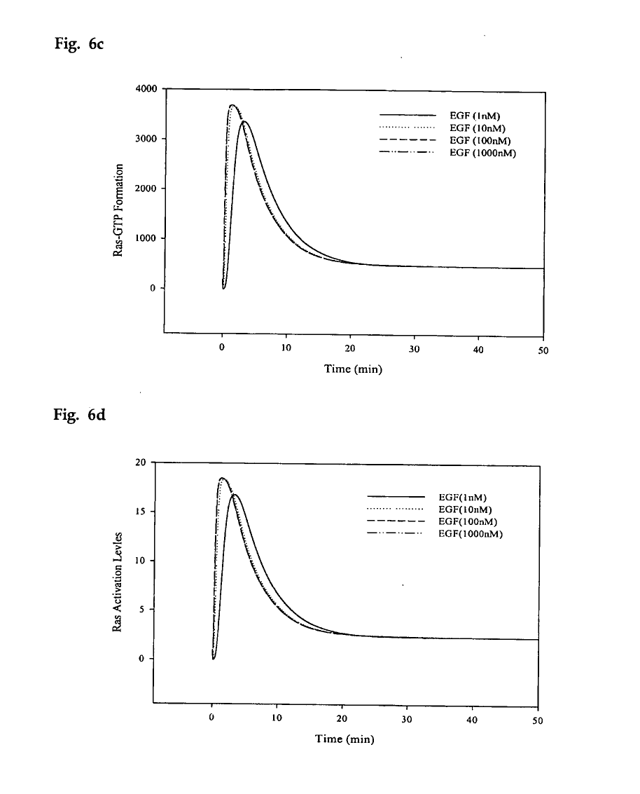

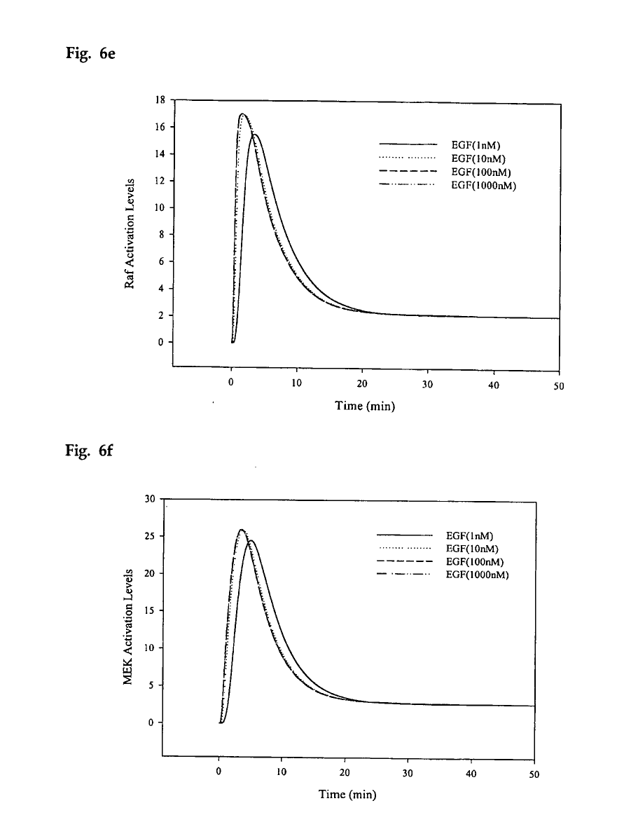

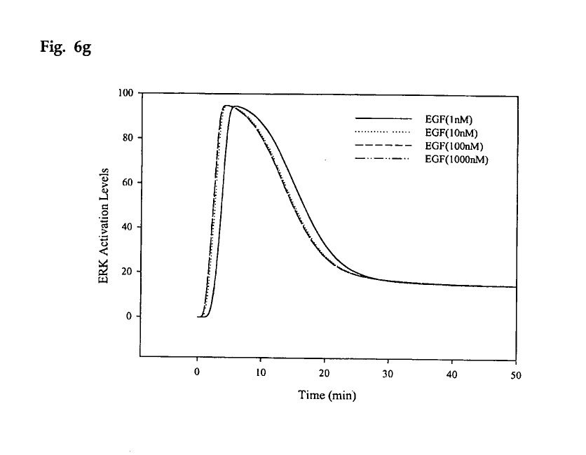

Biological results were collected by measuring intensities of activation and duration of time in each component involved in a signal transduction. In order to examine the effect of parameters, sensitivity analysis was performed to measure EGF concentration which is considered important in measuring the number of EGFR receptors most influential in the activation of each signal transduction component in response to environmental conditions. Since EGF, a signal transduction molecule, is the first component of serial reactions, the activation of downstream events in a signal transduction described in FIG. 3 was examined at each time interval to respond according to EGF concentrations (1, 10,100 and 1,000 nM)(FIGS. 6a to 6g).

EGFR has 2 different binding affinities (high and low) for EGF. The interaction with a high affinity has a dissociation constant (Kd)<1 nM and the interaction with a low affinity has a dissociation constant in 6 to 12 nM. At this moment, EGF concentration was adjusted to be greater than the Kd value of EGFR (Schoeberl et al., Nature Biotech., 20: 370-375, 2002).

The simulation result revealed that the activation of all the signal transduction molecules was delayed. Further, the activation level was shown to be lower at EGF with 1 nM as compared to at EGF with 10-1,000 nM. The activation level prediction became almost the same at a higher concentration of ligands (>10 mM). Accordingly, it was maintained at EGF with 100 nM to perform the above-mentioned analysis and following experiments.

FIG. 6a depicts the activation becomes about 150 times higher at a high EGF concentration than at a low EGF concentration. This model may predict 50% of EGFR activation at EGF with 100 nM. EGFR activation plot suggests that EGFR has a high affinity (Kd=1 nM), because its dissociation is slower than EGFR with a low affinity (Kd≧10 nM) which dissociates rapidly. Although the present inventors did not emphasize receptor internalization in this study, the simulation data accorded Wiley's research which discloses that the receptor internalization depends on receptors (Wiley H. S. et al., J. Biol. Chem., 266: 11083-11094, 1991; Wiley H. S., J. Cell Biol., 107: 801-810, 1998). Further, through the kinetic analysis of EGFR model it was confirmed that the specific internalization rate constant for EGF internalization becomes a few times larger at a lower concentration than that at a higher concentration. Then, EGF-receptor complex re-circulates rapidly after internalization. The rate of re-circulation of receptors which forms an EGF-receptor complex is slower than those receptors which do not form a complex with EGF.

The activation signals of Shc, Ras-GTP and Ras was intensified temporarily at 2 min, and then gradually attenuated according to time passage thus resembling a concentration-dependent signal in the pattern (FIGS. 6b-6d). On the other hand, the activation levels of Raf, MEK and ERK did not change regardless of a ligand concentration, as confirmed by examination of substances in MAKP signal transduction mechanism. In practice, ERK activation was estimated to 34% at EGF=1 nM, in contrast to >90% of predicted value under the same condition. This result shows the high efficiency of the transmitting signal. The higher level of ERK activation regardless of the ligand concentration also conforms to the model suggested in the present invention (Schoeberl et al., Nature Biotech., 20: 370-375, 2002). Therefore, it is confirmed that EGF concentration is not meaningful as a factor to reach a higher level of ERK activation, if the maximal activation in MAPK signal transduction is a goal to be attained (Schoeberl et al., Nature Biotech., 20: 370-375, 2002; Kholodenko B N. et al., J. Biol. Chem., 274: 30169-30181, 1999).

6. Evaluation of Effects of EGFR Over-Expression

The signal amplification toward a downstream target by activating receptors converts a traditional notion on serial mechanisms in the signal transduction into a network among highly entangled complexes.

Surplus receptors can gather additional molecules to transmit a signal and amplify the signal. It helps to evaluate EGFR expression and understand a mechanism of EGFR over-expression as well as to examine other molecules of EGF receptor group. Accordingly, the following simulation was conducted in order to evaluate the effects of the over-expression in EGFR receptor.

Several plausible mechanisms may be suggested on the basis of the results, according to activation levels of EGFR signal transduction molecules. Prior art has revealed that there are approximately 20,000 of EGFR receptors (Traverse S. et al., Current Biology, 4: 694-701, 1994). In the present invention, simulation was performed for EGFR models in the number of 5,550 to 200,000.

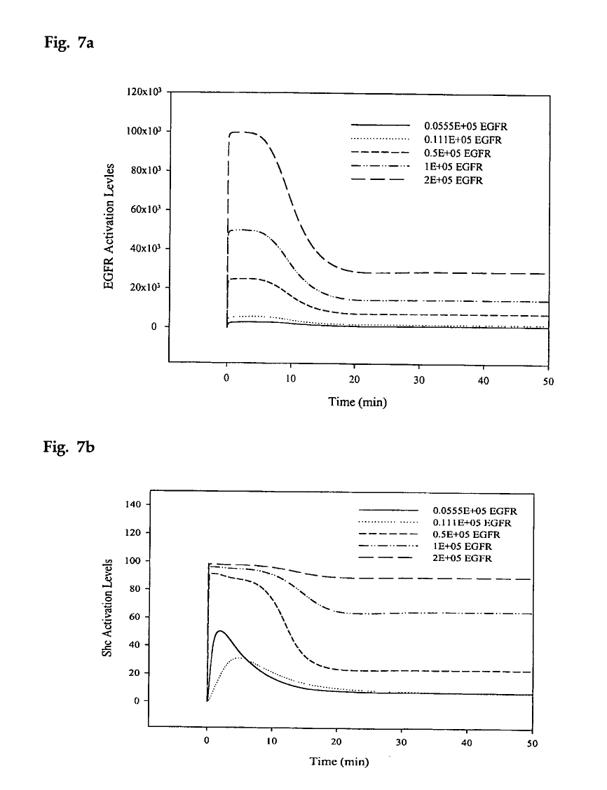

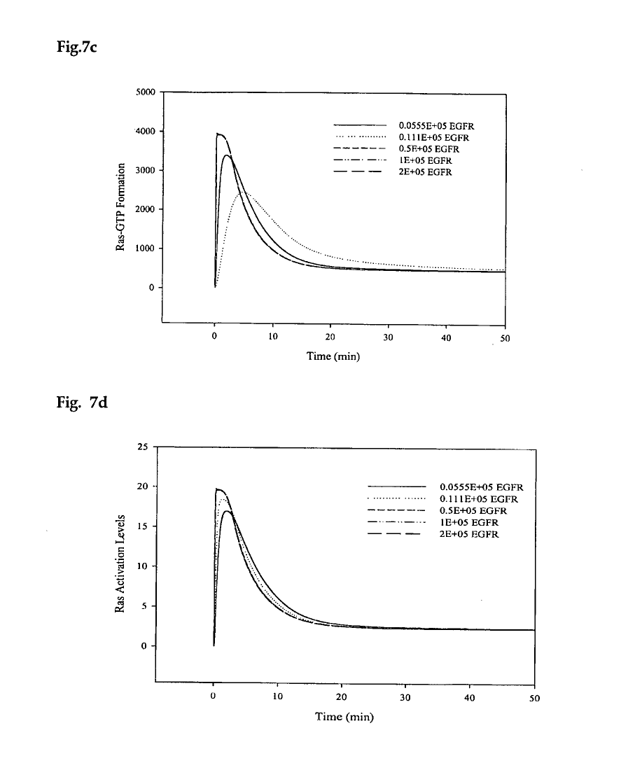

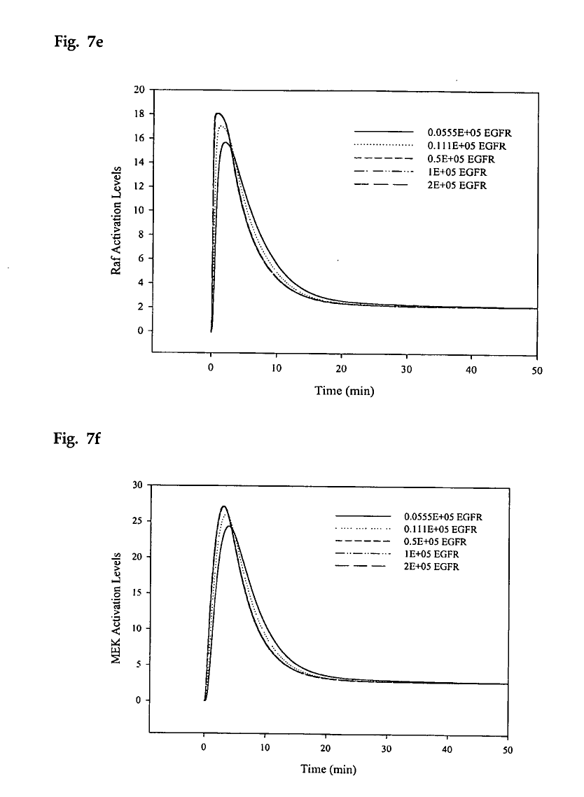

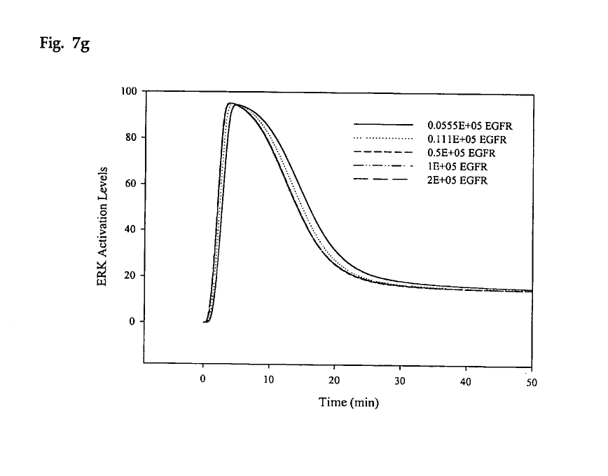

FIG. 7a to 7g depict the activation of each protein by using a function of time and EGFR number. EGFR may help to regulate the EGFR affinity for EGF. It has been reported that the increase in the density of receptors can control the binding kinetics of EGF assembly and the dissociation of the receptors [Wiley H. S., J. Cell Biol., 107: 801-810, 1998]. The model simulation demonstrated the enhancement of EGFR levels activated by the increase in the number of receptors.

Such an expression profile of each receptor does not influence the activation level of MAPK signal transduction. In all EGFR numbers, Raf and MEK demonstrated only a negligible amount of change in their activities, but ERK was not entirely changed but remain. In addition, Ras may act as a molecular switch to convert its state from inactive GDP bound to active GDP bound form. Interestingly, in this model, Shc and Ras-GTP demonstrated a different pattern of activation (See FIGS. 7b and 7c).

In the small number of receptors of about 11,100, the activation level of SHc and Ras-GTP was lower than those with 5,550 of receptors. However, in ≧11,100 of receptor number, the activation level of SHc and Ras-GTP showed a similar pattern to those of other components.

7. Simulation of Inhibitory Effect

Epithelial growth factor plays an important role in cell proliferation. With its absence, cell cycle will be arrested or inhibited to proceed, or cell apoptosis occurs [Aaronson, Science, 254: 1146-1153, 1991]. The importance of growth factors in tumor cells proliferation has been widely acknowledged. Clinical studies have shown that the over-expression of growth factor receptors, commonly occurring in human tumors, are closely related with a worse prognosis of primary breast cancer [Veale et al., Br. J. Cancer, 55: 513-516, 1987]. Based upon the knowledge, inhibitors against human EGF receptor have been developed [Fan et al., J. Bio. Chem., 269: 27595-27602, 1994]. The consistent activation of MAPK signal transduction may bring about malignant tumor in humans [Maemura et al., Oncology, 57: 37-42, 1999]. The ERK moves toward a nucleus if activated consistently, but if activated instantly, does not move in a large scale. [Kholododenko, Eur. J. Biochem., 276: 1583-1588, 2000].

The development of inhibitors against MAPK signal transduction is an important field of study. On the basis of the MAPK signal transduction, the efficacy of MEK inhibitors was investigated by the modeling analysis simulating ERK activation induced by EGF. Especially, PD09859 and U0126 are non-feedback inhibitors of dual-specific kinase and reported to suppress ERK activation. Both inhibitors have a similar inhibitory mechanism, but U0126 is more effective and specific in inhibit MAPK pathway (Traverse, et al., Biochem. J., 288: 351-355, 1922). These inhibitors may prevent MEK from ERK phosphorylation by suppressing the catalytic activity of MEK. Therefore, the rate constant of catalyst in MEK reaction is varied in order to simulate the inhibitory effect.

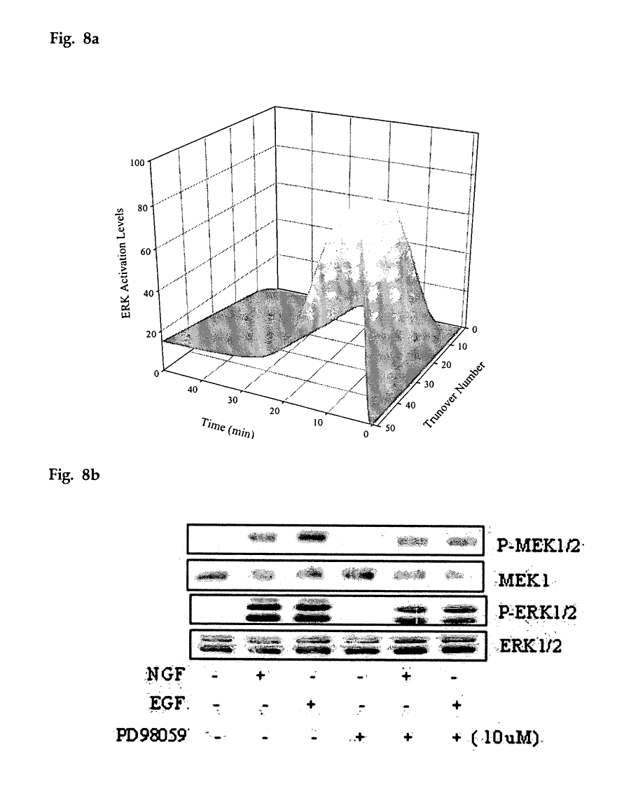

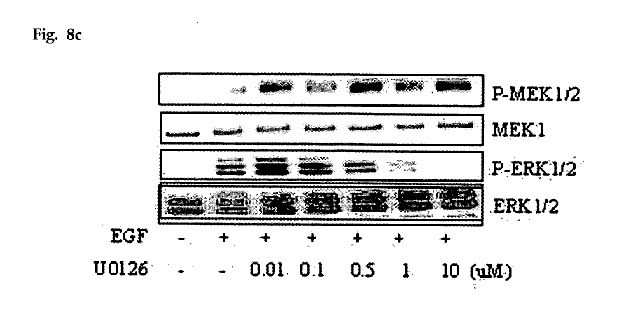

FIG. 8a depicts the ERK activation simulated by using 50 to 0.1/min of conversion number to indicate MEK phosphorylation. As a result, it was observed that the ERK activation levels gradually decreased, as the kinetic parameter of MEK phosphorylation changed. When K_{cat} was fixed at 0.5/min, it dropped zero point. The model simulation predicted a complete MEK inhibition to bring about ERK inhibition. This result corresponds with experimental observations. Such a kinetic terminology is useful to evaluate the inhibitory mechanism of kinases.

PC12 cells treated with EGF or nerve growth factor (NGF) were examined to evaluate the efficacies of PD09859 (10 μM) and U0126 (0.01-10 μM) in respect of MEK and ERK activation. Western blot analysis was performed as follows. PC12 cells treated with PD09859 and U0126 were treated with 100 ng/ml of EGF or NGF for 5 min. Then, the resulting protein sample was separated by performing SDS/PAGE, and then blotted by using anti-phosphorylated MEK and anti-diphosphoryated ERK antibodies. Again, the resultant was blotted by using anti-HRP (horseradish peroxidase) conjugated secondary antibodies and identified in bands by ECL chemo-luminescence.

As a consequence, the MEK activation became still higher, when treating EGF on PC12 cells. In contrast, when MAPK pathway was weakened simply by treating PD98059, the ERK activation was not suppressed, even if EGF and NGF were added. Further, when treating U0126, intracellular ERK phosphorylation was suppressed by the MEK activity dose-dependently, but the MEK activation was not suppressed. Although both results in the simulation and the experiment accord with each other, the model of the present invention did not predict the quantitative difference between the above two inhibitors.

### INDUSTRIAL APPLICABILITY

As illustrated and confirmed above, the present invention relates to a method and a system for modeling and simulating a biochemical pathway which comprises: (1) developing a mathematical dynamics model that applies biological data of signal transduction pathway within a biological system such as protein concentration as a parameter; and (2) simulating by using the same. The present invention enables protein functions, activation, interactions between proteins, signal transduction pathways and the like to be determined under overall environment, and a signal transduction network to be understood in both quantitative and qualitative levels. The simulation model of the present invention can be utilized to develop novel substances for a specified use such as medicine design even in a minimal trial. Further, it may promote to easily determine the application to improve the quality of target substance.

Those skilled in the art will appreciate that the conceptions and specific embodiments disclosed in the foregoing description may be readily utilized as a basis for modifying or designing other embodiments for carrying out the same purposes of the present invention.

Those skilled in the art will also appreciate that such equivalent embodiments do not depart from the spirit and scope of the invention as set forth in the appended claims.

1. A method for modeling a biochemical pathway comprising:
(1) collecting cellular environment information in a biochemical pathway; and
(2) modeling by using the cellular environment information and a differential equation on the basis of reaction rate formula and Michaelis-Menten equation.

2. A method for simulating a biochemical pathway comprising:
(1) providing cellular environment information and input information in a biochemical pathway;
(2) modeling by using the cellular environment information and a differential equation on the basis of reaction rate formula and Michaelis-Menten equation; and
(3) displaying a simulation result.

3. The method for simulating a biochemical pathway according to claim 1 or claim 2, wherein the cellular environment information is comprised of cellular material, processes, type and components; protein type, structure, composition and function; location of downstream cells; and activated or inhibitory effects.

4. The method for simulating a biochemical pathway according to claim 2, wherein the input information is comprised of a protein context, stimuli, knockout and endpoint.

5. A system for simulating a biochemical pathway comprising:
(1) a data input module 10 receiving cellular environment information and input information in a biochemical pathway;
(2) a simulation module 20 substituting the information into a differential equation on the basis of reaction rate formula and Michaelis-Menten equation to simulate;
(3) a database 30 storing the information; and
(4) a display module 40 generating data simulated above.

6. The system for simulating a biochemical pathway according to claim 5, wherein the simulation module is comprised of a graphic user interface 21 and an inference engine 22.

7. The system for simulating a biochemical pathway according to claim 5, wherein the cellular environment information is comprised of cellular material, processes, type and components; protein type, structure, composition and function; location of downstream cells; and the activated or inhibitory effects.

8. The method for simulating a biochemical pathway according to claim 5, wherein the input information is comprised of protein context, stimuli, knockout and endpoint.
